(19) United States
(12) Patent Application Publication
(10) Pub. No.: US 2025/0148342 A1
(43) Pub. Date: May 8, 2025

(54) SYSTEMS AND METHODS FOR QUANTUM AUTOCORRELATION COMPUTATION USING THE QFT

(71) Applicants: Aradhita Sharma, Tempe, AZ (US); Glen Uehara, Gilbert, AZ (US); Andreas Spanias, Tempe, AZ (US)

(72) Inventors: Aradhita Sharma, Tempe, AZ (US); Glen Uehara, Gilbert, AZ (US); Andreas Spanias, Tempe, AZ (US)

(73) Assignee: Arizona Board of Regents on Behalf of Arizona State University, Tempe, AZ (US)

(21) Appl. No.: 18/936,604

(22) Filed: Nov. 4, 2024

Related U.S. Application Data
(60) Provisional application No. 63/595,959, filed on Nov. 3, 2023.

(51) Int. Cl. G06N 10/60; G06N 10/40

(52) U.S. Cl. CPC G06N 10/60; G06N 10/40

(57) ABSTRACT

A novel approach for computing efficiently quantum based signal autocorrelations includes example designs associated with quantum circuits for computing the quantum autocorrelation of the signal. Importantly, to compensate for unique challenges associated with quantum signal processing (particularly regarding probabilistic measurements that result from QFT and IQFT operations), normalization and denormalization steps ensure that quantum measurement results are comparable to ranges that would be obtained with classical autocorrelation computation methods. In addition, because probabilistic measurements resulting from QFT and IQFT operations lose important phase information, lost phase information can be restored following measurement using QFT and IQFT.

### CROSS-REFERENCE TO RELATED APPLICATIONS

This is a U.S. Non-Provisional Patent Application that claims benefit to U.S. Provisional Patent Application Ser. No. 63/595,959 filed 3 Nov. 2023, which is herein incorporated by reference in its entirety.

### FIELD

The present disclosure generally relates to quantum computing and signal processing; and in particular to quantum correlation computation using the Quantum Fourier Transform (QFT).

### BACKGROUND

In signal processing, autocorrelation is often used to analyze signals and extract information from them. However, computing autocorrelation in the time domain by applying convolution involves a series of multiplications and additions resulting in a high computational complexity.

It is with these observations in mind, among others, that various aspects of the present disclosure were conceived and developed.

### SUMMARY

The present technology is directed towards a novel approach for computing efficiently quantum based signal autocorrelations. More specifically, quantum circuits are described for computing the quantum autocorrelation of the signal. Quantum encoding, QFT, and IQFT circuits used in the autocorrelation computation are presented. In general, the inventive concept includes a novel segmentation and normalization process, and a novel algorithm for computing autocorrelation.

In one illustrative example the inventive concept takes the form of a method that utilizes the Quantum Fourier Transform (QFT) for computing the autocorrelation of the signal. The proposed approach includes pre-processing, windowing, segmentation, and calculation of the power spectral density of the signal using novel QFT operations. The process also involves using appropriate segmentation and overlapping of the signal followed by an inverse quantum Fourier transform (IQFT). This approach to quantum autocorrelation computation allows parallel computations with the use of quantum principles and has the potential to offer advantages in terms of reducing computational complexity, enabling temporal and lag windowing, and facilitating overlap and overlap and saving approaches if needed.

Other example features include:
A novel segmentation and normalization process.
Quantum encoding of the normalized signal.
Computation of the power spectral density using the QFT.
A novel quantum QFT/IQFT algorithm is developed for computing autocorrelation.
Application to speech signals and computation of PSD and autocorrelation using QFT methods.
Characterization of quantum noise in autocorrelation computation.
Comparisons of quantum vs classical computation details on noise effects.
Normalization and denormalization of signals.
Models for quantum noise characterization are presented

The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1A is a simplified diagram showing a system for extracting a quantum autocorrelation sequence from an input signal.

FIG. 1B is a simplified block diagram showing an example sequence for extracting a quantum autocorrelation sequence from an input signal using the system of FIG. 1A.

FIG. 2 is a schematic diagram showing a Quantum Fourier Transform (QFT) circuit for 3 qubits after measurement.

FIG. 3 is a schematic diagram showing an Inverse Quantum Fourier Transform (IFQT) circuit for 3 qubits after measurement.

FIGS. 4A-4C are a series of process flow diagrams showing a method outlined herein for extracting a quantum autocorrelation sequence from an input signal.

FIG. 5 is a simplified block diagram showing an example computing device which can implement aspects of the system of FIG. 1A and the method of FIGS. 4A-4C.

Corresponding reference characters indicate corresponding elements among the view of the drawings. The headings used in the figures do not limit the scope of the claims.

### DETAILED DESCRIPTION

The present disclosure relates to quantum computing and signal processing and includes examples of systems and methods for quantum correlation using the Quantum Fourier Transform (QFT) for computing the autocorrelation of a signal, as described herein.

### Introduction:

Quantum computing offers unprecedented computational power and the ability to solve complex problems that are beyond the reach of classical computers. By leveraging the inherent parallelism of quantum systems, the signal processing field can be enhanced with more efficient computations. Inspired by this advantage, this disclosure presents the quantum computing algorithm for the computation of the autocorrelation of the signal.

In signal processing, autocorrelation is often used to analyze signals and extract information from them. However, computing autocorrelation in the time domain by applying convolution involves a series of multiplications and additions resulting in a high computational complexity. The introduction of the Fast Fourier Transform (FFT) accelerated the computation of autocorrelation sequences providing significant computational advantages over traditional methods by utilizing frequency domain representations of the signals. The present disclosure outlines systems and associated methods that employ a Quantum Fourier Transform (QFT) circuit for computing the autocorrelation of the signal. The methods outlined herein include pre-processing, windowing, segmentation, and calculation of the power spectral density of the signal using QFT operations. The methods also involve using appropriate segmentation and overlapping of the signal followed by an inverse quantum Fourier transform (IQFT). Importantly, to compensate for unique challenges associated with quantum signal processing (particularly regarding probabilistic measurements that result from QFT and IQFT operations), the systems and methods outlined herein incorporate normalization and denormalization steps to ensure that quantum measurement results are comparable to ranges that would be obtained with classical autocorrelation computation methods. In addition, because probabilistic measurements resulting from QFT and IQFT operations lose important phase information, the systems and methods outlined herein include steps that restore lost phase information following measurement using QFT and IQFT. This approach to quantum autocorrelation computation allows parallel computations with the use of quantum principles and has the potential to offer advantages in terms of reducing computational complexity, enabling temporal and lag windowing, and facilitating overlap and overlap and saving approaches if needed.

Quantum correlation, which is to be distinguished from classical signal correlation, is also referred to as entanglement. Entanglement is one of the fundamental concepts in quantum information theory. Previous studies have extensively investigated the utilization of quantum correlation functions to characterize coherence characteristics of optical fields in quantum optics, time-dependent chemical processes in spectroscopic applications, and correlations in condensed matter theory.

In this disclosure, a novel approach is described for efficiently computing quantum-based signal autocorrelations. More specifically, examples of quantum circuits and compensation strategies are presented for computing the quantum autocorrelation of the signal. Quantum encoding, QFT, and IQFT circuits used in the autocorrelation computation are presented. Qubit precision and quantum noise effects on the developed algorithm are also examined, and quantum autocorrelation results are compared with classical autocorrelation.

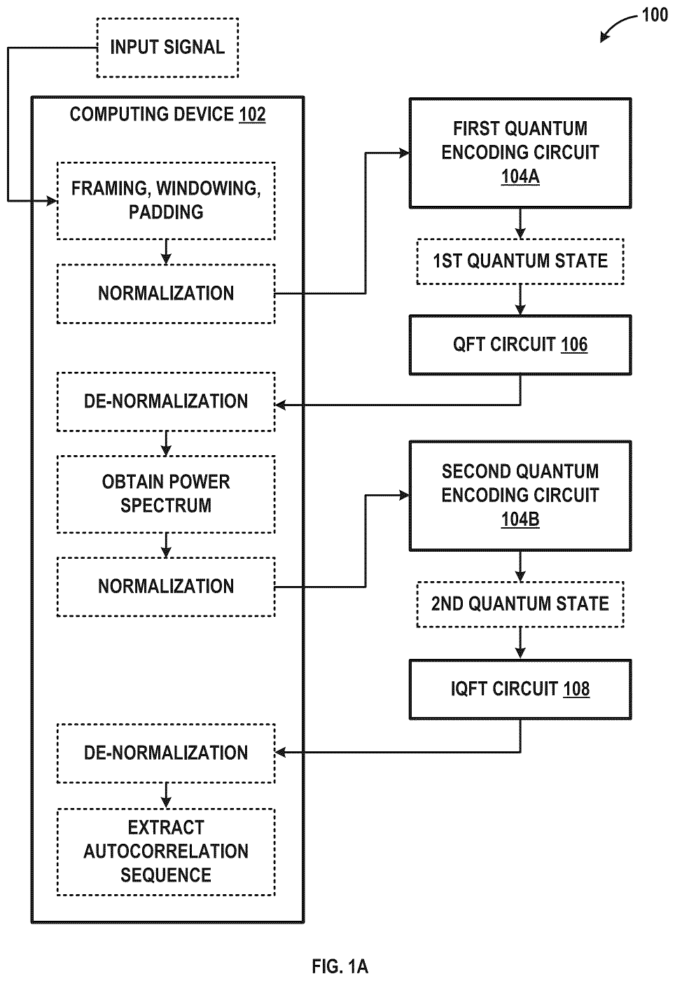

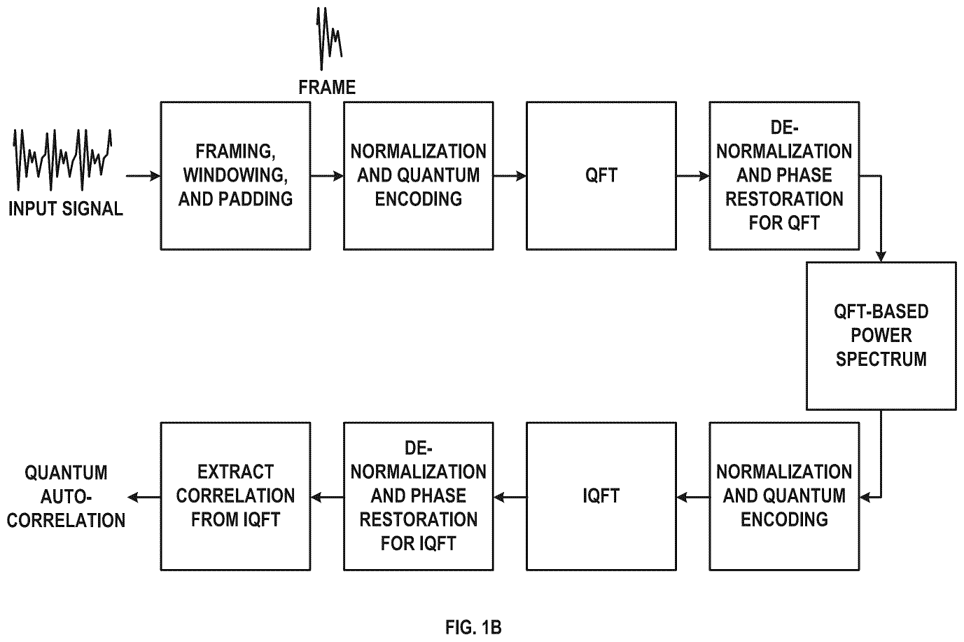

FIGS. 1A and 1B show an overview of a system 100 for extracting a quantum autocorrelation sequence from an input signal. As shown in FIG. 1A, the system 100 can include a computing device 102 which can be a classical computing device or a quantum computing device. The computing device 102 can communicate with various quantum circuits which can perform tasks including quantum encoding, evaluating a Quantum Fourier Transform (QFT), and evaluating an Inverse Quantum Fourier Transform (IQFT). As such, the system 100 can include one or more quantum encoding circuits (e.g., a first quantum encoding circuit 104A and a second quantum encoding circuit 104B), a QFT circuit 106, and an IQFT circuit 108.

The system 100 can generate, for an input signal and using the QFT circuit 106, de-normalized QFT coefficients associated with a frequency-domain representation of a first quantum state using a scaling factor that incorporates a norm and a quantity of qubits. The input signal can include, for example, a speech signal or another type of audio signal. The input signal could also include image or video signals (e.g., where each pixel needs a quantum signal representation). Further, the input signal could include other types of “big data” where there is a large quantity of data to process.

The system 100 can use the de-normalized QFT coefficients to obtain a power spectrum. Further, the system 100 can generate, for the power spectrum and using an IQFT circuit 108, de-normalized IQFT coefficients associated with the time-domain representation of the second quantum state using the scaling factor.

The de-normalized IQFT coefficients can be used to obtain a quantum autocorrelation sequence for the input signal which can be used for various downstream applications. For example, a downstream application can include quantum linear prediction which can be used for file compression, speech recognition and interpretation, and voice enhancement. Quantum signal processing can be particularly helpful for massive datasets.

Importantly, to compensate for unique challenges posed by using quantum computing to obtain the quantum autocorrelation sequence, the system 100 employs normalization and de-normalization steps to ensure that quantum measurement results are comparable to ranges that would be obtained with classical autocorrelation computation methods. In addition, the system 100 implements phase restoration steps following measurement at the QFT circuit 106 and IQFT circuit 108, as quantum measurement results are probabilistic in nature.

### Normalization for Quantum Encoding of a Signal

In order to process an input signal using quantum encoding, there is a need to first encode the input signal as a quantum state. Before quantum encoding, the input signal is normalized with a norm factor such that the square of all the amplitude values sums up to 1; that is,

$${α}_{0}^{2} + {α}_{1}^{2} + … + {α}_{N - 1}^{2} = 1 \qquad ( 1 )$$

where αₙ are the input signal values and where the input signal is of length N. Therefore, the input signal is normalized using the linear norm,

$$norm = \sqrt{{\sum }_{n = 0}^{N - 1} {α}_{n}^{2}} \qquad ( 2 )$$

and the normalized input signal is hₙ=αₙ/norm. For an input signal of length N, the input signal is encoded as a first quantum state:

$$\vert ψ 〉 = {\sum }_{n = 0}^{N - 1} {h}_{n} \vert n 〉 \qquad ( 3 )$$

with N basis states |n [symbol] by using m number of qubits where N=2^{m}. When the input signal is encoded, the square of the wavefunctions (hₙ) associated with the basis states |n [symbol] sums up to 1; that is: h₀²+h₁²+ . . . +h_{N-1}²=1.

### The Quantum Fourier Transform (QFT)

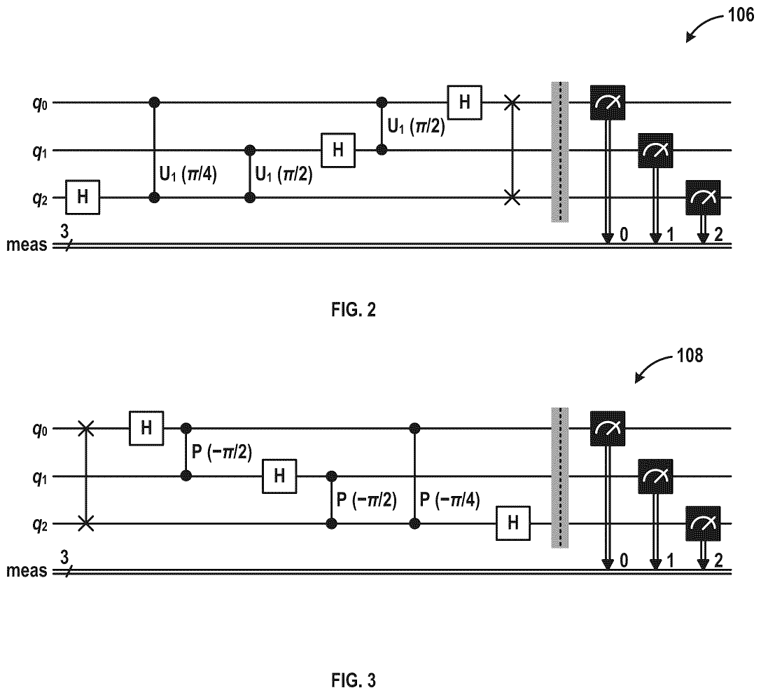

The quantum-encoded signal (as the first quantum state |ψ [symbol] ) is then passed to a QFT circuit, shown in FIG. 2. The purpose of calculating a Fourier Transform is to obtain a frequency-domain representation of an input signal. In this case, the QFT circuit can be used to measure a first probabilistic distribution associated with a frequency-domain representation of the first quantum state |ψ [symbol] . The QFT for a basis state |n [symbol] of the first quantum state |ψ [symbol] can be calculated as:

$$QFT \vert n 〉 \to \frac{1}{\sqrt{N}} {\sum }_{k = 0}^{N - 1} {e}^{2 π ikn / N} \vert k 〉 \qquad ( 4 )$$

where |n [symbol] =|nₘ₋₁ . . . n₁n₀ [symbol] and |k [symbol] =|kₘ₋₁ . . . k₁k₀) is their binary representation. Similarly, the inverse of QFT (IQFT) of a basis state |k [symbol] can be calculated as

$$IQFT \vert k 〉 \to \frac{1}{\sqrt{N}} {\sum }_{n = 0}^{N - 1} {e}^{- 2 π ikn / N} \vert n 〉 \qquad ( 5 )$$

The mathematical derivation of QFT and its implementation for signal analysis synthesis can be conducted as described in Sharma, Aradhita, et al. “Signal Analysis-Synthesis Using the Quantum Fourier Transform.” ICASSP 2023-2023 IEEE International Conference on Acoustics, Speech and Signal Processing (ICASSP). IEEE, 2023; Nielsen, M. A. & Chuang, I. L., 2011. Quantum Computation and Quantum Information: 10th Anniversary Edition, Cambridge University Press; and Shor, Peter W. “Algorithms for quantum computation: discrete logarithms and factoring.” IEEE FOCS, 1994 incorporated by reference.

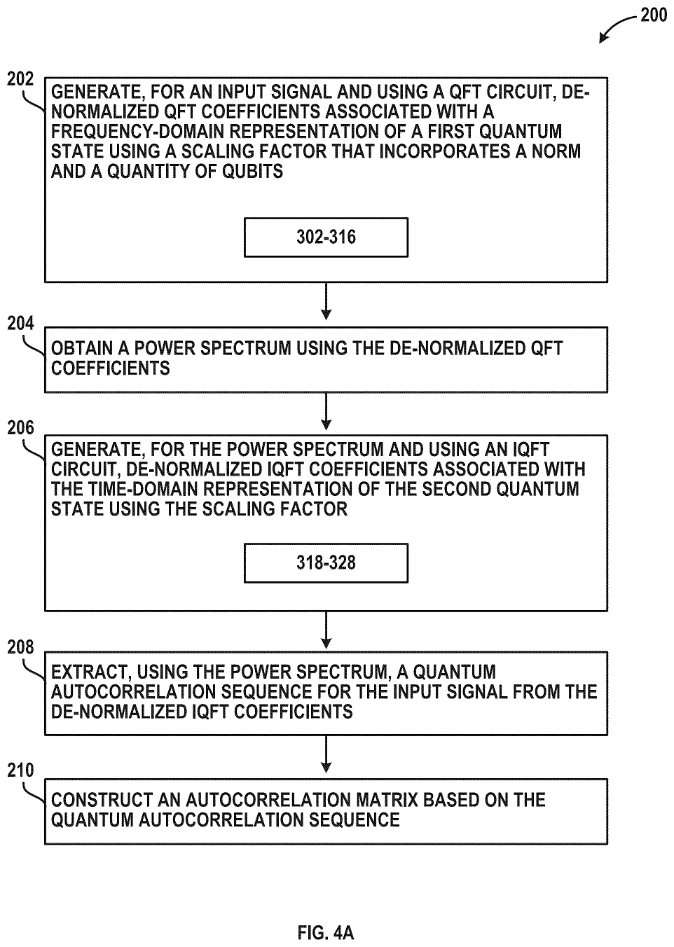

The constructed quantum circuit designs for QFT and IQFT are respectively shown in FIG. 2 and FIG. 3. The QFT circuit of FIG. 2 is measured to obtain the frequency domain representation of the input signal as the output of the QFT. The complexity of QFT computation is 0(m²) where m is the number of qubits, whereas the computational complexity of FFT is 0(N log N)=0(2^{m} m). Therefore, an exponential speedup is observed in the QFT computation due to the parallelism property of quantum systems.

### De-Normalization of Quantum Results

The QFT of the first quantum state |ψ [symbol] can also be represented as:

$$QFT \vert ψ 〉 = {p}_{0} \vert {n}_{0} 〉 + {p}_{1} \vert {n}_{1} 〉 + … + {p}_{N - 1} \vert {n}_{N - 1} 〉 \qquad ( 6 )$$

where pₙ is the wavefunction value, and pₙ² corresponds to the probabilistic values associated with the quantum basis. The output of the QFT circuit is measured for many shots (e.g., 10000) to obtain a probabilistic distribution (Pₙ) associated with the frequency-domain representation of the first quantum state |ψ [symbol] after measurement. However, measuring the output of the QFT circuit, results in a loss of phase information because the measured results are in terms of probabilistic values. Therefore, to restore the phase information of the input signal, the QFT coefficients associated with the frequency-domain representation of the first quantum state can be formatted in Euler form that incorporates, for a basis state |n [symbol] of the first quantum state |ψ [symbol] , a real component Re(pₙ) and an imaginary component Im(pₙ) of a wavefunction value (pₙ) associated with the basis state |n [symbol] as obtained from measurement of the first probabilistic distribution (Pₙ). The QFT coefficients including both probability values after measurement and the phase obtained from the wavefunction is expressed in Euler's form as in equation (7). Similarly, the IQFT coefficients can be calculated.

$${QFT}_{n} = \sqrt{{p}_{n}^{2}} \cdot {e}^{i \cdot {tan}^{- 1} ( \frac{Im ( {p}_{n} )}{Re ( {p}_{n} )} )} \qquad ( 7 )$$

Since these results are in probabilistic range, the result cannot be compared to the classical autocorrelation. Therefore, de-normalization (a scaling factor) is helpful to have quantum results comparable to the classical results range. The scaling factors are developed by taking into account the norm and number of qubits (m), and this scaling factor is used for the de-normalization of QFT and IQFT coefficients; post de-normalization, the coefficients are updated as:

$${QFT}_{n} = {QFT}_{n} * norm * \sqrt{{2}^{m}} \qquad ( 8.1 )$$

$${IQFT}_{n} = {IQFT}_{n} * norm / \sqrt{{2}^{m}} \qquad ( 8.2 )$$

### Quantum Autocorrelation

An example of the developed quantum autocorrelation algorithm block diagram is shown in FIG. 1. This quantum autocorrelation is based on the QFT and IQFT computations, which are described as follows.

For calculating the quantum autocorrelation of a signal using QFTs, the signal is preprocessed by doing frame segmentation using overlapping of frames, and windowing of the signal. The windowed frame signal is normalized to satisfy equation (1). However, a circular effect can occur due to the periodic nature of Fourier transforms leading to undesired artifacts and inaccurate autocorrelation estimation. Therefore, to mitigate these circular effects, the input frame signal is zero-padded to 2N length, and this padded normalized signal is quantum encoded to be represented as a quantum state. This quantum state is passed to the QFT circuit and measurement is performed. From the measurement results, the QFT coefficients are calculated using equation (7), and are de-normalized using equation (8). From the obtained QFT coefficients, the power spectrum (Sₖ) of the signal is calculated by multiplying the QFT coefficients with its complex conjugate.

$${S}_{k} = {QFT}_{n} {QFT}_{n}^{*} \qquad ( 9 )$$

Once the QFT based power spectrum is obtained, novel normalization and encoding stages are used and the signal is quantum encoded in terms of a quantum state and passed as an input to the IQFT circuit. The IQFT coefficients are obtained after the measurement of the circuit and de-normalization. From these IQFT coefficients, we extract the quantum autocorrelation sequence rₓ(τ) using equation (10).

$${r}_{x} ( τ ) = IQFT \vert {S}_{k} 〉 \qquad ( 10 )$$

Based on the quantum autocorrelation sequence obtained, an autocorrelation matrix Rₓ is constructed as

$${R}_{x} = [ \begin{matrix}{r}_{x} ( 0 ) & {r}_{x}^{*} ( 1 ) & … & {r}_{x}^{*} ( p ) \\ {r}_{x} ( 1 ) & {r}_{x} ( 0 ) & … & {r}_{x}^{*} ( p - 1 ) \\ ⋮ & ⋮ & ⋱ & ⋮ \\ {r}_{x} ( p ) & {r}_{x} ( p - 1 ) & … & {r}_{x} ( 0 )\end{matrix} ] \qquad ( 11 )$$

The resulting quantum autocorrelation sequences can be used for various applications including radar, communications, denoising, system identification, correlograms and linear prediction.

### Methods:

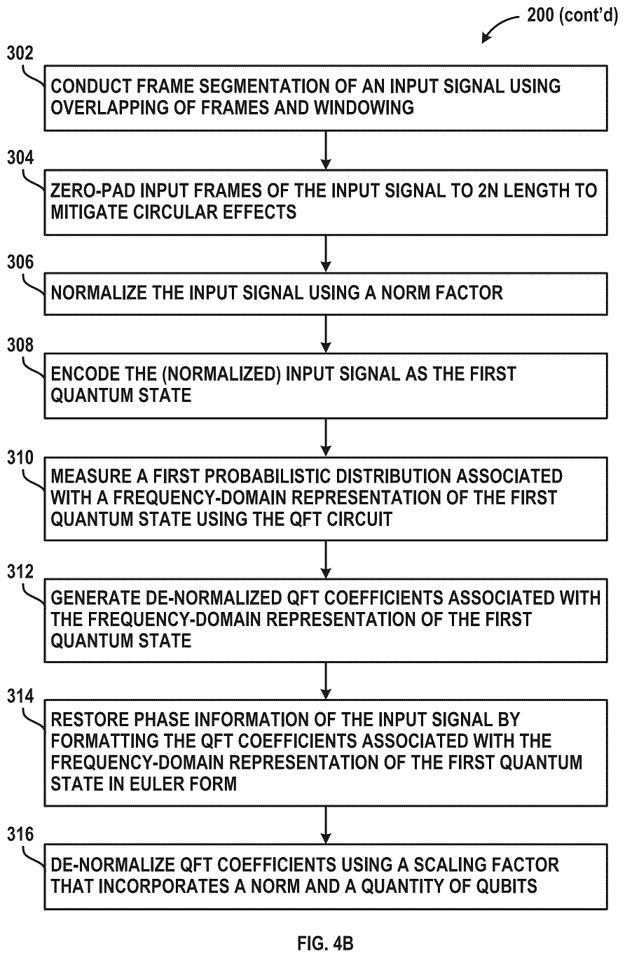

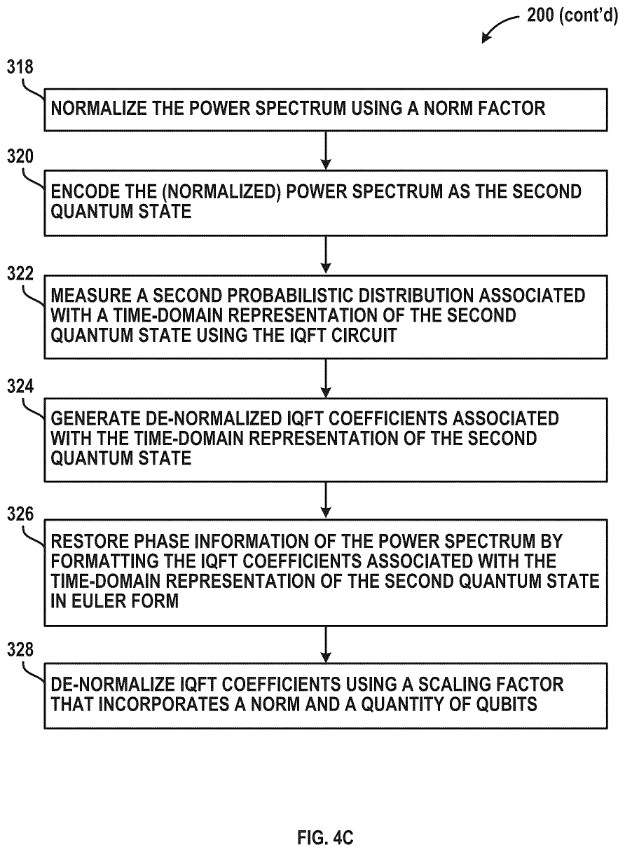

FIGS. 4A-4C show a method 200 for determining a quantum autocorrelation of an input signal. FIG. 4A shows a simplified overview of the method 200 which can be implemented as outlined herein with respect to FIGS. 1A-3, and may be implemented using the system 100 outlined in FIG. 1A.

Referring to FIG. 4A, step 202 of method 200 includes generating, for an input signal and using the QFT circuit 106, de-normalized QFT coefficients associated with a frequency-domain representation of a first quantum state using a scaling factor that incorporates a norm and a quantity of qubits. The input signal can include, for example, a speech signal. Step 202 can encompass steps 302-316 shown in FIG. 4B, outlined in further detail below.

Step 204 of method 200 shown in FIG. 4A includes obtaining a power spectrum using the de-normalized QFT coefficients by multiplying the de-normalized QFT coefficients with a complex conjugate of the de-normalized QFT coefficients as in equation (9).

Step 206 of method 200 shown in FIG. 4A includes generating, for the power spectrum and using the IQFT circuit 108, de-normalized IQFT coefficients associated with the time-domain representation of the second quantum state using the scaling factor. Step 206 can encompass steps 318-328 shown in FIG. 4C, outlined in further detail below.

Step 208 of method 200 shown in FIG. 4A includes extracting, using the power spectrum, a quantum autocorrelation sequence for the input signal from the de-normalized IQFT coefficients as in equation (10). Step 210 of method 200 shown in FIG. 4A includes constructing an autocorrelation matrix based on the quantum autocorrelation sequence as in equation (11).

Referring to step 302 of method 200 shown in FIG. 4B, which elaborates on step 202 of FIG. 4A, the system 100 (e.g., by computing device 102 of FIG. 1A) can conduct frame segmentation of an input signal using overlapping of frames and windowing prior to normalization of the input signal. In addition, at step 304 of method 200, the system 100 can zero-pad input frames of the input signal to 2N length to mitigate circular effects associated with the frequency-domain representation of the first quantum state.

Further, the system 100 can normalize and encode the input signal as a first quantum state as in equation (1). In particular, corresponding to step 306 of method 200, the system 100 (e.g., by computing device 102 of FIG. 1A) can normalize the input signal using a norm factor such that a total sum of squares of all amplitude values of the input signal is equal to 1 as in equation (2). Following normalization, at step 308 of method 200, the system 100 (e.g., by first quantum encoding circuit 104A of FIG. 1A) can encode the (normalized) input signal as the first quantum state having N basis states using m=log₂ N qubits as in equation (3). The first quantum state has a wavefunction associated with a basis state of the N basis states such that a total sum of squares of all wavefunctions of the first quantum state sums to 1.

Following normalization and encoding of the input signal into the first quantum state, as shown in step 310 of method 200, the system 100 (by QFT circuit 106 of FIG. 1A) can measure a first probabilistic distribution associated with a frequency-domain representation of the first quantum state as in equation (6).

Corresponding to step 312 of method 200, the system 100 can generate (e.g., by computing device 102 of FIG. 1A) de-normalized QFT coefficients associated with the frequency-domain representation of the first quantum state. Further, the measurements from the QFT circuit 106 being probabilistic results in a loss in phase information. At step 314 of method 200, the system 100 can restore phase information of the input signal by formatting the QFT coefficients associated with the frequency-domain representation of the first quantum state in Euler form (as in equation (7)) that incorporates, for a basis state of the first quantum state, a real component and an imaginary component of a wavefunction value associated with the basis state as obtained from measurement of the first probabilistic distribution. At step 316 of method 200, the system 100 can de-normalize the QFT coefficients using a scaling factor that incorporates a norm and a quantity of qubits as in equation (8.1).

As mentioned above with respect to FIG. 4A, corresponding to step 204 of method 200, the system 100 can obtain a power spectrum of the input signal by multiplying the de-normalized QFT coefficients with a complex conjugate of the de-normalized QFT coefficients as in equation (9).

The system 100 can normalize and encode the power spectrum obtained from the de-normalized QFT coefficients as a second quantum state. Referring to step 318 of method 200 shown in FIG. 4C, which elaborates on step 206 of FIG. 4A, the system 100 (e.g., by computing device 102 of FIG. 1A) can normalize the power spectrum using a norm factor such that a total sum of squares of all amplitude values of the power spectrum is equal to 1 following similar convention from equation (2). Following normalization, at step 320 of method 200, the system 100 can encode (e.g., by second quantum encoding circuit 104B of FIG. 1A) the (normalized) power spectrum as the second quantum state having N basis states using m=log₂ N qubits as in equation (???). The second quantum state has a wavefunction associated with a basis state of the N basis states such that a total sum of squares of all wavefunctions of the first quantum state sums to 1.

Following normalization and encoding of the power spectrum into the second quantum state, as shown in step 322 of method 200, the system 100 (by IQFT circuit 108 of FIG. 1A) can measure a second probabilistic distribution associated with a time-domain representation of the second quantum state using the IQFT circuit 108 as in equation (5).

Corresponding to step 324 of method 200, the system 100 can generate (e.g., by computing device 102 of FIG. 1A) de-normalized IQFT coefficients associated with the time-domain representation of the second quantum state. Further, similar to the QFT circuit 106, the measurements from the IQFT circuit 108 being probabilistic results in a loss in phase information. As such, at step 326 of method 200, the system 100 can restore phase information of the power spectrum by formatting the IQFT coefficients associated with the time-domain representation of the second quantum state in Euler form (as in equation (7)) that incorporates, for a basis state of the second quantum state, a real component and an imaginary component of a wavefunction value associated with the basis state as obtained from measurement of the second probabilistic distribution. At step 328 of method 200, the system 100 can de-normalize the IQFT coefficients using a scaling factor that incorporates a norm and a quantity of qubits (m) as in equation (8.2).

As discussed above, at step 210 of method 200 shown in FIG. 4A, the system 100 can extract, using the power spectrum, a quantum autocorrelation sequence for the input signal from the de-normalized IQFT coefficients as in equation (10). Further, at step 210 of method 200, the system 100 can construct an autocorrelation matrix based on the quantum autocorrelation sequence as in equation (11).

The quantum autocorrelation sequence can be used for various downstream applications, such as determining one or more quantum linear prediction coefficients for the input signal based on the quantum autocorrelation sequence.

### Quantum Noise Effects:

Quantum noise refers to the inherent fluctuations and disturbances that affect quantum systems and can impact the results of quantum circuit computations. To study the impact of quantum noise in the present developed quantum autocorrelation algorithm, phase-amplitude damping error is introduced to all the qubits in the circuit to simulate the effect of noise in the quantum circuit. Phase-amplitude damping error is a form of quantum noise that introduces both phase damping (loss of phase coherence in a quantum state) and amplitude damping (loss of energy from a quantum state to the environment) effects. With the introduction of quantum noise, the realistic behavior of quantum systems is simulated and the robustness of the present quantum correlation computation algorithm is studied.

### Results for QFT-Based Quantum Autocorrelation of the Signal

The subject novel quantum signal autocorrelation algorithm is evaluated for speech signals. The quantum autocorrelation sequence is obtained for speech signals and compared with the classical autocorrelation by calculating the Mean Squared Error (MSE) between quantum and classical autocorrelation results. This comparison is performed for different numbers of qubits used to represent the input frame signal to analyze the effect of qubit precision. MSE results averaged for 10 frames are shown in Table 1, and it is seen that the calculated MSE value between classical and quantum autocorrelation was found to be very low, indicating a high level of precision. It is observed that there is a slight increase in MSE values with an increasing number of qubits, because of the increasing quantum circuit complexity, but it is almost negligible. This result suggests that the present quantum autocorrelation approach produces comparable results to the classical autocorrelation of the signal.

However, upon introducing quantum noise through phase-amplitude damping error, the computed results showed a drastic increase in MSE calculated between classical autocorrelation and quantum autocorrelation with quantum noise effects. This demonstrates the detrimental impact of quantum noise on the accuracy of quantum computations in comparison to without noise computations. Although there was an increase in MSE compared to the no noise quantum computations, the observed MSE for quantum noise scenario remained relatively low. This indicates that the quantum autocorrelation algorithm described herein still produces results that are highly comparable to the classical correlation computation results.

TABLE 1
MSE comparing classical vs quantum correlations.

| Qubits | 5 | 6 | 7 | 8 |
|---|---|---|---|---|
| MSE | 3.45e−32 | 6.65e−32 | 1.03e−31 | 1.33e−31 |
| MSE with quantum noise | 1.76e−05 | 2.22e−05 | 3.37e−05 | 7.61e−05 |

### Computing Device

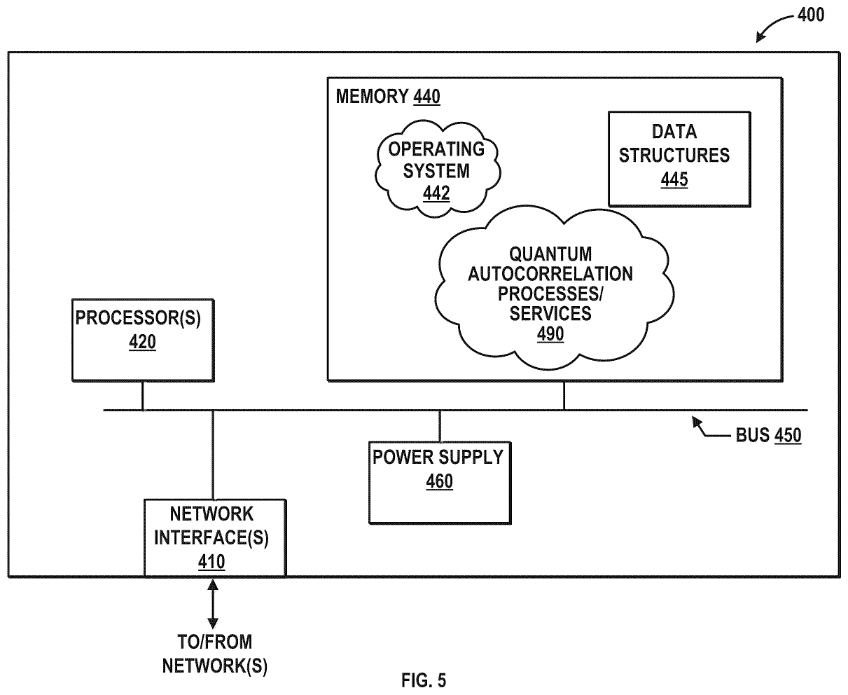

FIG. 5 is a schematic block diagram of an example device 400 that may be used with one or more embodiments described herein, e.g., as a component of computing device 102 of FIG. 1A, which can be a classical computing device. In other examples, device 400 can be a quantum computing device. Device 400, as computing device 102 of FIG. 1A, can communicate with the quantum circuits shown in FIG. 1A including but not limited to the one or more quantum encoding circuits (e.g., the first quantum encoding circuit 104A and the second quantum encoding circuit 104B), the QFT circuit 106, and the IQFT circuit 108.

Device 400 comprises one or more network interfaces 410 (e.g., wired, wireless, PLC, etc.), at least one processor 420, and a memory 440 interconnected by a system bus 450, as well as a power supply 460 (e.g., battery, plug-in, etc.).

Network interface(s) 410 include the mechanical, electrical, and signaling circuitry for communicating data over the communication links coupled to a communication network. Network interfaces 410 are configured to transmit and/or receive data using a variety of different communication protocols. As illustrated, the box representing network interfaces 410 is shown for simplicity, and it is appreciated that such interfaces may represent different types of network connections such as wireless and wired (physical) connections. Network interfaces 410 are shown separately from power supply 460, however it is appreciated that the interfaces that support PLC protocols may communicate through power supply 460 and/or may be an integral component coupled to power supply 460.

Memory 440 includes a plurality of storage locations that are addressable by processor 420 and network interfaces 410 for storing software programs and data structures associated with the embodiments described herein. In some embodiments, device 400 may have limited memory or no memory (e.g., no memory for storage other than for programs/processes operating on the device and associated caches). Memory 440 can include instructions executable by the processor 420 that, when executed by the processor 420, cause the processor 420 to implement aspects of the system 100 and the method 200 outlined herein.

Processor 420 comprises hardware elements or logic adapted to execute the software programs (e.g., instructions) and manipulate data structures 445. An operating system 442, portions of which are typically resident in memory 440 and executed by the processor, functionally organizes device 400 by, inter alia, invoking operations in support of software processes and/or services executing on the device. These software processes and/or services may include quantum autocorrelation processes/services 490, which can include aspects of method 200 and/or implementations of various modules described herein. Note that while quantum autocorrelation processes/services 490 is illustrated in centralized memory 440, alternative embodiments provide for the process to be operated within the network interfaces 410, such as a component of a MAC layer, and/or as part of a distributed computing network environment. Memory 440 can include non-transitory computer readable media including instructions encoded thereon that are executable by the processor 420 to implement quantum autocorrelation processes/services 490 (e.g., which can include aspects of method 200, particularly those which are to be implemented by computing device 102).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the quantum autocorrelation processes/services 490 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for quantum autocorrelation computation of a signal, comprising:
normalizing and encoding an input signal as a first quantum state;
measuring a first probabilistic distribution associated with a frequency-domain representation of the first quantum state using a Quantum Fourier Transform (QFT) circuit;
generating de-normalized QFT coefficients associated with the frequency-domain representation of the first quantum state using a scaling factor that incorporates a norm factor and a quantity of qubits;
normalizing and encoding a power spectrum obtained from the de-normalized QFT coefficients as a second quantum state;
measuring a second probabilistic distribution associated with a time-domain representation of the second quantum state using an Inverse Quantum Fourier Transform (IQFT) circuit;
generating de-normalized IQFT coefficients associated with the time-domain representation of the second quantum state using the scaling factor; and
extracting, using the power spectrum, a quantum autocorrelation sequence for the input signal from the de-normalized IQFT coefficients.

2. The method of claim 1, further comprising:
obtaining the power spectrum of the input signal by multiplying the de-normalized QFT coefficients with a complex conjugate of the de-normalized QFT coefficients.

3. The method of claim 1, further comprising:
restoring phase information of the input signal by formatting QFT coefficients associated with the frequency-domain representation of the first quantum state in Euler form that incorporates, for a basis state of the first quantum state, a real component and an imaginary component of a wavefunction value associated with the basis state as obtained from measurement of the first probabilistic distribution.

4. The method of claim 1, further comprising:
normalizing the input signal using the norm factor such that a total sum of squares of all amplitude values of the input signal is equal to 1.

5. The method of claim 1, further comprising:
encoding the input signal as the first quantum state having N basis states using log₂ N qubits following normalization of the input signal.

6. The method of claim 5, the first quantum state having a wavefunction associated with a basis state of the N basis states such that a total sum of squares of all wavefunctions of the first quantum state sums to 1.

7. The method of claim 1, further comprising:
conducting frame segmentation using overlapping of frames and windowing of the input signal prior to normalization of the input signal.

8. The method of claim 1, further comprising:
zero-padding input frames of the input signal to 2N length to mitigate circular effects associated with the frequency-domain representation of the first quantum state.

9. The method of claim 1, further comprising constructing an autocorrelation matrix based on the quantum autocorrelation sequence.

10. The method of claim 1, the input signal including a speech signal.

11. The method of claim 1, further comprising:
determining one or more quantum linear prediction coefficients for the input signal based on the quantum autocorrelation sequence.

12. A system, comprising:
a computing device in communication with a Quantum Fourier Transform (QFT) circuit and an Inverse Quantum Fourier Transform (IQFT) circuit, the computing device including a processor and a memory, the memory including instructions executable by the processor to:
generate, for an input signal and using a measured output of the QFT circuit, de-normalized QFT coefficients associated with a frequency-domain representation of a first quantum state using a scaling factor that incorporates a norm factor and a quantity of qubits;
obtain a power spectrum from the de-normalized QFT coefficients;
generate, for the power spectrum and using a measured output of the IQFT circuit, de-normalized IQFT coefficients associated with a time-domain representation of a second quantum state using the scaling factor; and
extract, using the power spectrum, a quantum autocorrelation sequence for the input signal from the de-normalized IQFT coefficients.

13. The system of claim 12, the computing device further including instructions executable by the processor to:
normalize the input signal using the norm factor such that a total sum of squares of all amplitude values of the input signal is equal to 1;
apply, following normalization, the input signal to a first quantum encoding circuit that encodes the input signal as the first quantum state having N basis states using log₂ N qubits, the first quantum state having a wavefunction associated with a basis state of the N basis states such that a total sum of squares of all wavefunctions of the first quantum state sums to 1; and
measure a first probabilistic distribution associated with the frequency-domain representation of the first quantum state by application of the first quantum state as input to the QFT circuit and by measurement of an output of the QFT circuit.

14. The system of claim 13, the computing device further including instructions executable by the processor to:
restore phase information of the input signal by formatting QFT coefficients associated with the frequency-domain representation of the first quantum state in Euler form that incorporates, for a basis state of the first quantum state, a real component and an imaginary component of a wavefunction value associated with the basis state as obtained from measurement of the first probabilistic distribution.

15. The system of claim 12, the computing device further including instructions executable by the processor to:
normalize and encode the power spectrum obtained from the de-normalized QFT coefficients as the second quantum state, encoding the power spectrum including application of the power spectrum following normalization as input to a second quantum encoding circuit that encodes the power spectrum as the second quantum state; and
measure a second probabilistic distribution associated with the time-domain representation of the second quantum state by application of the second quantum state as input to the IQFT circuit and by measurement of an output of the IQFT circuit.

16. The system of claim 12, the computing device further including instructions executable by the processor to:
conduct frame segmentation using overlapping of frames and windowing of the input signal prior to normalization of the input signal; and
zero-pad input frames of the input signal to 2N length to mitigate circular effects associated with the frequency-domain representation of the first quantum state.

17. The system of claim 12, the input signal including a speech signal.

18. A non-transitory computer-readable medium including instructions encoded thereon, the instructions being executable by a processor to:
generate, for an input signal and using a measured output of a Quantum Fourier Transform (QFT) circuit in communication with a processor, de-normalized QFT coefficients associated with a frequency-domain representation of a first quantum state using a scaling factor that incorporates a norm factor and a quantity of qubits;
obtain a power spectrum from the de-normalized QFT coefficients;
generate, for the power spectrum and using a measured output of an Inverse Quantum Fourier Transform (IQFT) circuit in communication with the processor, de-normalized IQFT coefficients associated with a time-domain representation of a second quantum state using the scaling factor; and
extract, using the power spectrum, a quantum autocorrelation sequence for the input signal from the de-normalized IQFT coefficients.

19. The non-transitory computer-readable medium of claim 18, further including instructions encoded thereon, the instructions being executable by the processor to:
normalize the input signal using the norm factor such that a total sum of squares of all amplitude values of the input signal is equal to 1;
apply, following normalization, the input signal to a first quantum encoding circuit that encodes the input signal as the first quantum state having N basis states using log₂ N qubits, the first quantum state having a wavefunction associated with a basis state of the N basis states such that a total sum of squares of all wavefunctions of the first quantum state sums to 1; and
measure a first probabilistic distribution associated with the frequency-domain representation of the first quantum state by application of the first quantum state as input to the QFT circuit and by measurement of an output of the QFT circuit.

20. The non-transitory computer-readable medium of claim 18, further including instructions encoded thereon, the instructions being executable by the processor to:
normalize and encode the power spectrum obtained from the de-normalized QFT coefficients as the second quantum state, encoding the power spectrum including application of the power spectrum following normalization as input to a second quantum encoding circuit that encodes the power spectrum as the second quantum state; and
measure a second probabilistic distribution associated with the time-domain representation of the second quantum state by application of the second quantum state as input to the IQFT circuit and by measurement of an output of the IQFT circuit.
